(19) United States
(12) Patent Application Publication
(10) Pub. No.: US 2008/0229751 A1
(43) Pub. Date: Sep. 25, 2008

(54) Cooling system for gas turbine engine having improved core system

(75) Inventors: Robert Joseph Orlando, West Chester, OH (US); Kattalaicheri Srinivasan Venkataramani, West Chester, OH (US); Ching-Pang Lee, Cincinnati, OH (US)

Correspondence Address: James P. Davidson, Esq., 8375 Ashmont Way, Mason, OH, 45040, US

(73) Assignee: General Electric Company

(21) Appl. No.: 11/657,829

(22) Filed: Jan. 25, 2007

Related U.S. Application Data
(62) Division of application No. 10/941,547, filed on Sep. 15, 2004, now abandoned.

(51) Int. Cl. F02C 7/08

(52) U.S. Cl. 60/736

(57) ABSTRACT

A gas turbine engine having a longitudinal centerline axis therethrough, including: a fan section at a forward end of the gas turbine engine including at least a first fan blade row connected to a first drive shaft; a booster compressor positioned downstream of and in at least partial flow communication with the fan section including a plurality of stages, each stage including a stationary compressor blade row and a rotating compressor blade row connected to a drive shaft and interdigitated with the stationary compressor blade row; a core system positioned downstream of the booster compressor, the core system further comprising a combustion system for producing pulses of gas having increased pressure and temperature from a fluid flow provided to an inlet thereof so as to produce a working fluid at an outlet; a low pressure turbine positioned downstream of and in flow communication with the core system, the low pressure turbine being utilized to power the first drive shaft; and, a system for cooling the combustion system, wherein fuel is utilized as a cooling fluid prior to being supplied to the combustion system. The core system may further include an intermediate compressor positioned downstream of and in flow communication with the compressor connected to a second drive shaft; and an intermediate turbine positioned downstream of the combustion system in flow communication with the working fluid.

This application is a divisional of Ser. No. 10/941,547, filed on Sep. 15, 2004, currently pending.

### BACKGROUND OF THE INVENTION

The present invention relates generally to a gas turbine engine design having an improved core system which replaces the high pressure system of conventional gas turbine engines and, in particular, to a cooling system associated with such core system.

It is well known that typical gas turbine engines are based on the ideal Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such gas turbine engines generally rely upon deflagrative combustion to burn a fuel/air mixture and produce combustion gas products which travel at relatively slow rates and relatively constant pressure within a combustion chamber. While engines based on the Brayton Cycle have reached a high level of thermodynamic efficiency by steady improvements in component efficiencies and increases in pressure ratio and peak temperature, further improvements are becoming increasingly more difficult to obtain.

Although the combustors utilized in the conventional gas turbine engine are the type where pressure therein is maintained substantially constant, improvements in engine cycle performance and efficiency have been obtained by operating the engine so that the combustion occurs as a detonation in either a continuous or pulsed mode. Several pulse detonation system designs, for example, have been disclosed by the assignee of the present invention in the following patent applications: (1) “Pulse Detonation Device For A Gas Turbine Engine,” having Ser. No. 10/383,027; (2) “Pulse Detonation System For A Gas Turbine Engine,” having Ser. No. 10/405,561; (3) “Integral Pulse Detonation System For A Gas Turbine Engine” having Ser. No. 10/418,859; (4) “Rotating Pulse Detonation System For A Gas Turbine Engine” having Ser. No. 10/422,314; and, (5) “Rotary Pulse Detonation System With Aerodynamic Detonation Passages For Use In A Gas Turbine Engine” having Ser. No. 10/803,293.

It will be appreciated that a pulse detonation device produces pulses of hot gas that are of approximately the same pressure. Time averaged pressure of such pulses are similar in magnitude to the pressure generated in a typical low pressure turbine engine, but at a higher temperature than normally associated with the low pressure turbine engine. It will be understood that a constant volume combustor similarly produces pulses of high-pressure, high-temperature gas that can also be utilized in the pulse detonation type of arrangement. An example of a stationary constant volume combustor is disclosed in U.S. Pat. No. 3,877,219 to Hagen, while a constant volume combustor including a rotatable element is disclosed in U.S. Pat. No. 5,960,625 to Zdvorak, Sr.

In this way, the core or high pressure system of the conventional gas turbine engine may be replaced with a more efficient and less complicated system involving a different type of combustor. At the same time, the modified gas turbine engine will be able to retain the conventional low pressure turbine, as well as the conventional operability characteristics thereof. The cooling system of the present invention may be utilized as an alternative to those cooling systems for gas turbine engines having improved core systems as disclosed in patent applications entitled, “Gas Turbine Engine Having Improved Core System,” Ser. No. ______, and “High Thrust Gas Turbine Engine Having Improved Core System,” Ser. No. ______, which are also owned by the assignee of the present invention and filed concurrently herewith. As seen in these applications, the cooling systems utilize a portion of the compressed air supplied to an inlet of the combustion system. Such compressed air for cooling may be employed in a system providing impingement cooling, but is not practical for the combustion systems utilized (i.e., pulse detonation or constant volume combustion) in a system which provides film cooling. This stems from the pressure being higher in the combustion device than the incoming air without additional compression of the cooling air.

Accordingly, it would be desirable for a practical overall architecture be developed for a gas turbine engine utilizing a pulse detonation device or a constant volume combustor in order to further improve overall engine efficiency. Further, it would be desirable for such architecture to incorporate a cooling system and method which mitigates the pulsing nature of the combustion discharge and reduces engine noise. At the same time, it is also desirable for such cooling system to employ the more efficient film cooling method without undue modification.

### BRIEF SUMMARY OF THE INVENTION

In accordance with a first embodiment of the present invention, a gas turbine engine having a longitudinal centerline axis therethrough is disclosed as including a fan section at a forward end of the gas turbine engine including at least a first fan blade row connected to a first drive shaft; a booster compressor positioned downstream of and in at least partial flow communication with the fan section including a plurality of stages, each stage including a stationary compressor blade row and a rotating compressor blade row connected to a drive shaft and interdigitated with the stationary compressor blade row; a core system positioned downstream of the booster compressor, the core system further comprising a combustion system for producing pulses of gas having increased pressure and temperature from a fluid flow provided to an inlet thereof so as to produce a working fluid at an outlet; a low pressure turbine positioned downstream of and in flow communication with the core system, the low pressure turbine being utilized to power the first drive shaft; and, a system for cooling the combustion system, wherein fuel is utilized as a cooling fluid prior to being supplied to the combustion system. The core system may further include an intermediate compressor positioned downstream of and in flow communication with the compressor connected to a second drive shaft and an intermediate turbine positioned downstream of the combustion system in flow communication with the working fluid.

In accordance with a second embodiment of the present invention, a method of cooling a combustion system of a gas turbine engine including a booster compressor having a plurality of stages is disclosed as including the steps of providing fuel as a cooling fluid to the combustion system; and, supplying the fuel to the combustion system.

In accordance with a third embodiment of the present invention, a gas turbine engine is disclosed as including: a compressor positioned at a forward end of the gas turbine engine having a plurality of stages, each stage including a stationary compressor blade row and a rotatable blade row connected to a drive shaft and interdigitated with the stationary compressor blade row; a core system positioned downstream of the compressor, the core system further comprising a combustion system for producing pulses of gas having increased pressure and temperature from a fluid supplied to an inlet thereof so as to produce a working fluid at an outlet thereof; a turbine downstream of and in flow communication with the combustion system for powering the drive shaft; a load connected to said drive shaft; and, a system for cooling the combustion system, wherein fuel is utilized as a cooling fluid prior to being supplied to the combustion system. The core system may further include an intermediate compressor positioned downstream of and in flow communication with the compressor connected to a second drive shaft and an intermediate turbine positioned downstream of the combustion system in flow communication with the working fluid.

### BRIEF DESCRIPTION OF THE DRAWINGS

FIG. 1 is a diagrammatic view of a gas turbine engine configuration including a prior art core system where a system of cooling is depicted therein;

FIG. 2 is a diagrammatic view of a gas turbine engine configuration including a core system in accordance with the present invention having a stationary combustion device, where a first cooling system is shown as including a heat exchanger integrated with such combustion device;

FIG. 3 is a diagrammatic view of the gas turbine engine configuration depicted in FIG. 2, where a first alternative cooling system is shown as including a heat exchanger separate from the combustion device;

FIG. 4 is a diagrammatic view of the gas turbine engine depicted in FIG. 2, where a second alternative cooling system is shown as including a first heat exchanger separate from the combustion device and a second heat exchanger integral with the combustion device;

FIG. 5 is a diagrammatic view of a gas turbine engine configuration including a core system in accordance with the present invention having a rotating combustion device, where the cooling system of FIG. 2 is shown therewith;

FIG. 6 is a diagrammatic view of the gas turbine engine configuration depicted in FIG. 5, where the cooling system of FIG. 3 is shown therewith;

FIG. 7 is a diagrammatic view of the gas turbine engine configuration depicted in FIG. 5, where the cooling system of FIG. 4 is shown therewith;

FIG. 8 is a diagrammatic view of an alternative gas turbine engine configuration including a core system in accordance with the present invention having a stationary combustion device, where the cooling system of FIG. 2 is shown therewith; and,

FIG. 9 is a diagrammatic view of the gas turbine engine configuration depicted in FIG. 8, where the cooling system of FIG. 3 is shown therewith;

FIG. 10 is a diagrammatic view of the gas turbine engine configuration depicted in FIG. 8, where the cooling system of FIG. 4 is shown therewith;

FIG. 11 is a diagrammatic view of the alternative gas turbine engine configuration including a core system in accordance with the present invention having a rotating combustion device, where the cooling system of FIG. 2 is shown therewith;

FIG. 12 is a diagrammatic view of the alternative gas turbine engine configuration depicted in FIG. 11, where the cooling system of FIG. 3 is shown therewith; and,

FIG. 13 is a diagrammatic view of the alternative gas turbine engine configuration depicted in FIG. 11, where the cooling system of FIG. 4 is shown therewith.

### DETAILED DESCRIPTION OF THE INVENTION

Referring now to the drawings in detail, wherein identical numerals indicate the same elements throughout the figures, FIG. 1 diagrammatically depicts a conventional gas turbine engine 10 (high bypass type) utilized with aircraft having a longitudinal or axial centerline axis 12 therethrough for reference purposes. A flow of air (represented by arrow 14) is directed through a fan section 16, with a portion thereof (represented by arrow 18) being provided to a booster compressor 20. Thereafter, a first compressed flow (represented by arrow 22) is provided to a core or high pressure system 25.

More specifically, core system 25 includes a high pressure compressor 24 which supplies a second compressed flow 26 to a combustor 28. It will be understood that combustor 28 is of the constant pressure type which is well known in the art. A high pressure turbine 30 is positioned downstream of combustor 28 and receives gas products (represented by arrow 32) produced by combustor 28 and extracts energy therefrom to drive high pressure compressor 24 by means of a first or high pressure drive shaft 34. It will further be understood that high pressure compressor 24 not only provides second compressed flow 26 to an inlet of combustor 28, but also may provide a cooling flow (represented by dashed arrow 42) to combustor 28.

A low pressure turbine 36 is located downstream of core system 25 (i.e., high pressure turbine 30), where gas products (represented by arrow 38) flow therein and energy is extracted to drive booster compressor 20 and fan section 16 via a second or low pressure drive shaft 40. The remaining gas products (represented by arrow 41) then exit gas turbine engine 10. It will be appreciated that fan section 16 generally includes at least one row of fan blades connected to second drive shaft 40. It will also be understood that booster compressor 20 and high pressure compressor 24 preferably include a plurality of stages, where each stage of booster compressor 20 includes a stationary compressor blade row and a rotating compressor blade row connected to second drive shaft 40 and interdigitated with the stationary compressor blade row.

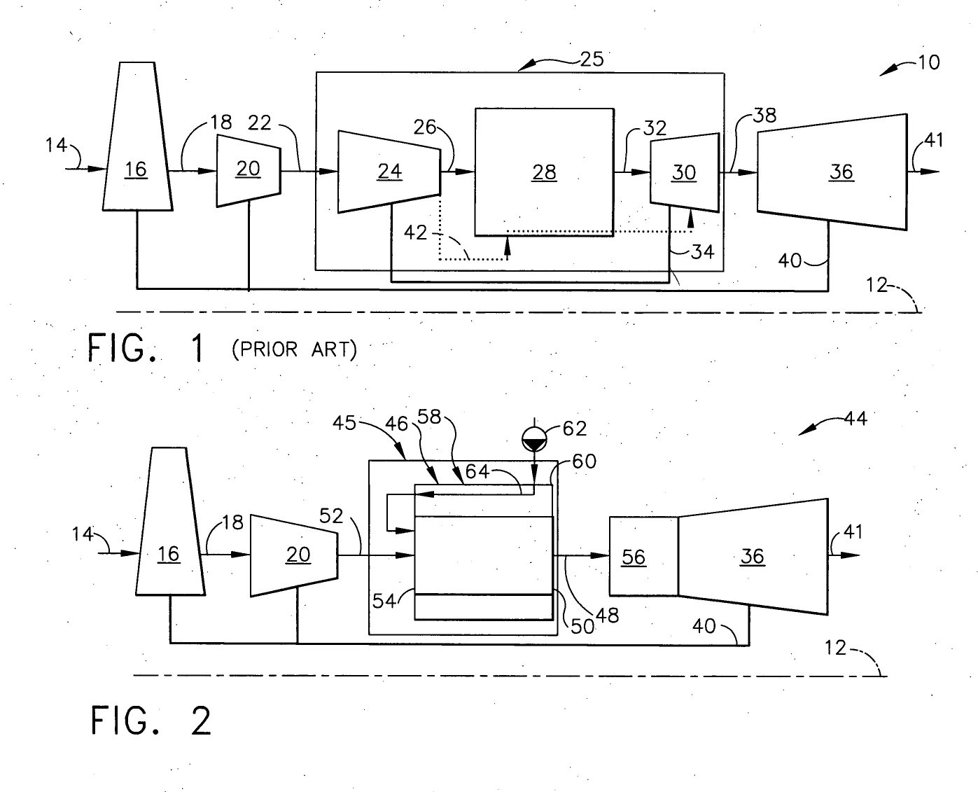

As seen in FIG. 2, gas turbine engine 44 similarly includes longitudinal centerline axis 12, air flow 14 to fan section 16, air flow 18 to booster compressor 20, and low pressure drive shaft 40 through which low pressure turbine 36 drives fan section 16 and booster compressor 20. Gas turbine engine 44, however, includes a new core system 45 which primarily involves a combustion system 46. Combustion system 46, which may be either a constant volume type combustor or a pulse detonation system, produces a working fluid (represented by arrow 48) consisting of gas pulses at an exit 50 having increased pressure and temperature compared to an air flow (represented by arrow 52) supplied to an inlet 54 thereof. Contrary to combustor 28 utilized in core system 25 described hereinabove, combustion system 46 does not maintain a relatively constant pressure therein. Moreover, core system 45 operates substantially according to an ideal Humphrey cycle instead of the ideal Brayton cycle in core system 25.

It will be seen that working fluid 48 is preferably provided to a turbine nozzle 56 positioned immediately upstream of low pressure turbine 36 so as to direct its flow at an optimum orientation into low pressure turbine 36. In the embodiment depicted in FIG. 2, combustion system 46 is stationary so that low pressure turbine 36 necessarily drives both fan section 16 and booster compressor 20 by means of drive shaft 40.

A cooling system identified generally by reference numeral 58 is associated with core system 45, where a heat exchanger 60 is preferably integrated with combustion system 46. More specifically, it will be seen that a pump 62 provides fuel 64 directly to heat exchanger 60 prior to entering inlet 54 of combustion system 46.

In this way, the sensible heat of fuel 64 and latent heat of vaporization allows fuel 64 to absorb heat from the hot walls of combustion system 46 and provide cooling thereto without the need for cooling air. In addition to cooling combustion system 46, fuel 64 is vaporized during the transit time through heat exchanger 60 prior to injection into combustion system 46. As such, initiating the combustion process in combustion system 46, whether as a detonation or a deflagration, is easier in a gaseous or vaporized state than as a liquid. Because one major concern in using fuel 64 directly with heat exchanger 60 as the cooling medium for combustion system 46 is the tendency for gum and/or coke deposits to form, it is preferred that heat exchanger 60 employ the designs disclosed in U.S. Pat. No. 5,805,973 to Coffinberry et al. and U.S. Pat. No. 5,247,792 to Coffinberry, which are also assigned to the assignee of the present invention.

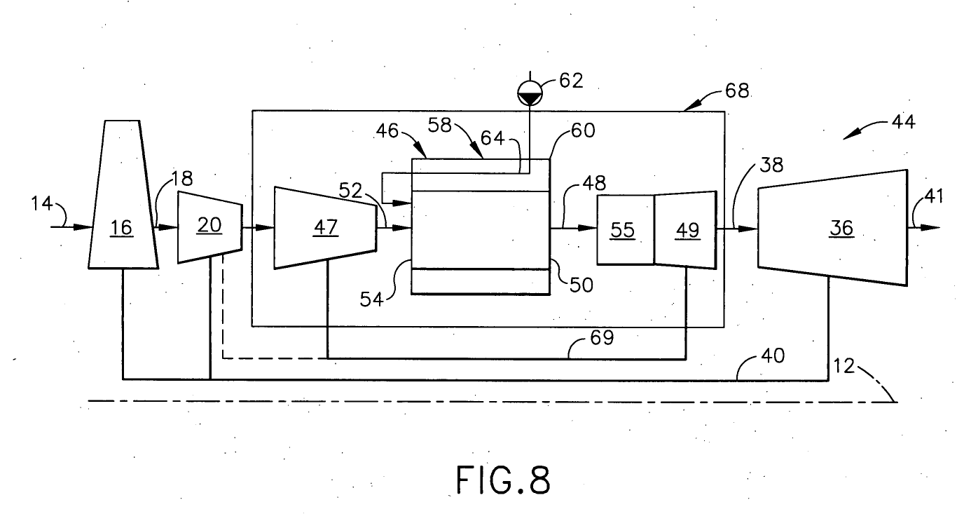

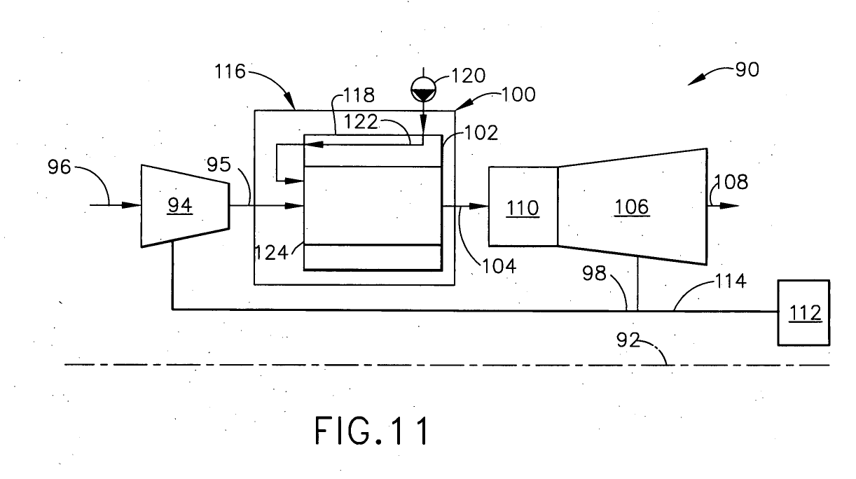

Cooling system 58 may also be implemented in other gas turbine configurations, as seen in FIGS. 5, 8, and 11. With respect to FIG. 5, combustion system 46 includes a rotatable member so that it powers a drive shaft 66 that preferably drives booster compressor 20. In this way, low pressure turbine 36 is able to drive fan section 16 separately via drive shaft 40. In FIG. 8, a core system 68 therein preferably includes an intermediate compressor 47 located immediately downstream of booster compressor 20 and an intermediate turbine 49 (with a turbine nozzle 55 immediately upstream) positioned between combustion system 46 and low pressure turbine 36. This enables gas turbine engine 44 to generate greater thrust. It will further be seen that intermediate turbine 49 powers a drive shaft 69 that drives intermediate compressor 47, and possibly booster compressor 20 (as depicted by the dashed line extending from drive shaft 69 to booster compressor 20). Gas turbine engine 90 in FIG. 11 will be discussed in greater detail herein, but also utilizes a cooling system 116 like that described above.

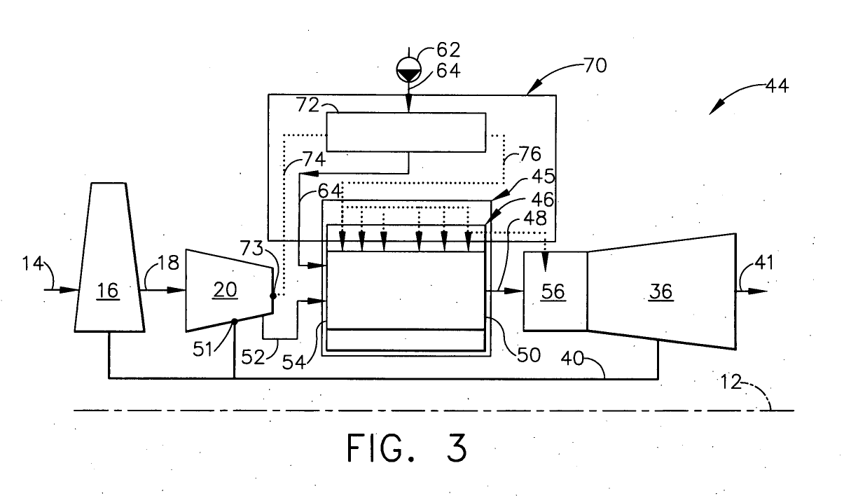

As seen in FIG. 3, gas turbine engine 44 includes an alternative cooling system 70 in which fuel 64 is indirectly utilized to cool combustion system 46. More specifically, a heat exchanger 72 which is not integral with the walls of combustion system 46 is provided. Compressed air 74 is provided to heat exchanger 72 from booster compressor 20, which is cooled by the introduction of fuel 64 to heat exchanger 72. Thereafter, a flow of cooled compressed air 76 is utilized to cool combustion system 46. The transfer of heat from compressed air 74 to fuel 64 in heat exchanger 72 promotes the vaporization of fuel 64 prior to being injected at inlet 54 of combustion system 46. It will be appreciated that the pressure of cooling flow 76 must be greater than compressed flow 52 provided to combustion system 46. Accordingly, it is preferred that compressed flow 52 originate from a first source 51 (e.g., a port at a mid-stage of booster compressor 20) which is upstream of a second source 73 (e.g., an aft end of booster compressor 20) that provides compressed flow 74 to cooling system 70. By configuring cooling system 70 this way, the concerns of fuel 64 gumming or coking as in cooling system 58 are avoided. Moreover, as noted in the '______ and '______ patent applications, introducing cooling flow 76 to turbine nozzle 56 provides the added benefit of damping the unsteadiness of working fluid 48 provided to low pressure turbine 36. Further, noise is mitigated and smooth operation of gas turbine engine 44 is enabled.

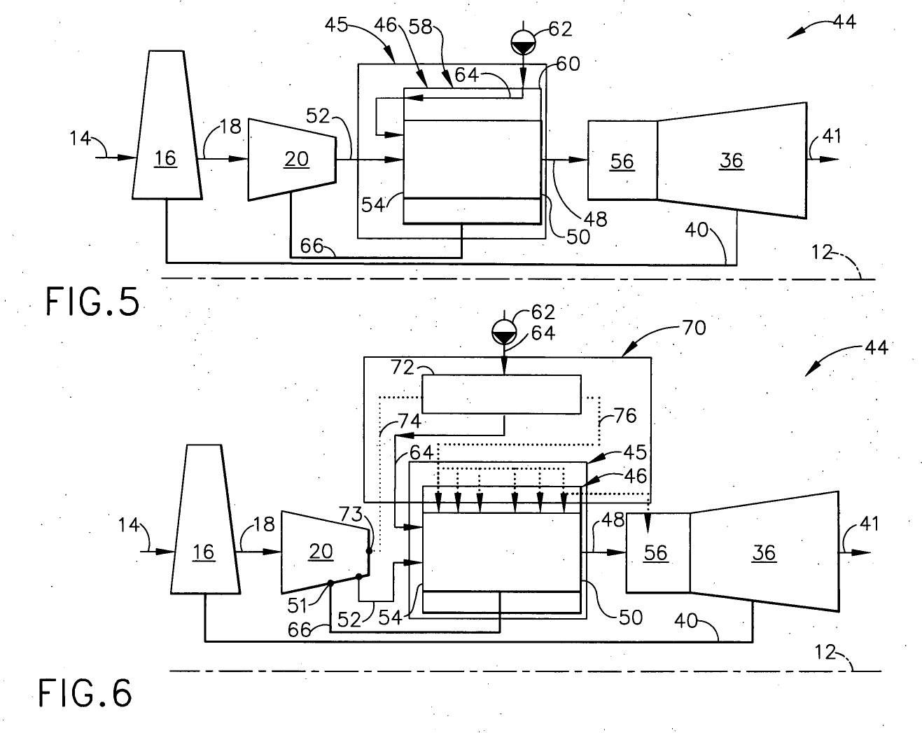

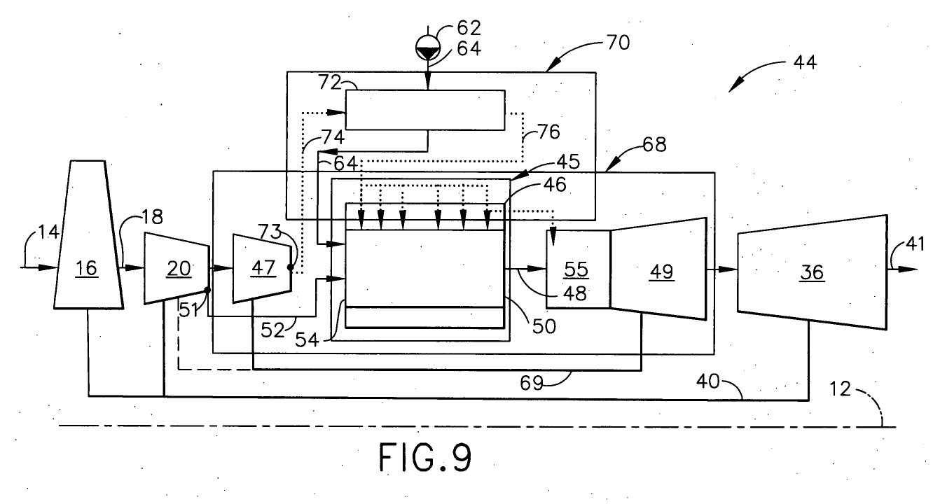

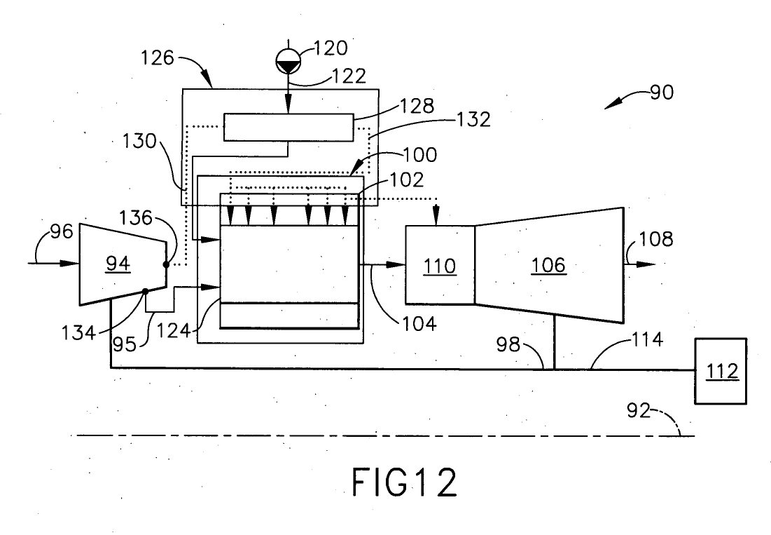

Cooling system 70 may also be implemented in other gas turbine configurations, as seen in FIGS. 6, 9 and 12. With respect to FIG. 6, combustion system 46 includes a rotatable member so that it powers drive shaft 66 (as discussed above for FIG. 5) and therefore preferably drives booster compressor 20. In this way, low pressure turbine 36 is able to drive fan section 16 separately via drive shaft 40. In FIG. 9, core system 68 preferably includes intermediate compressor 47 located immediately downstream of booster compressor 20 and intermediate turbine 49 positioned between combustion system 46 and low pressure turbine 36. Thus, intermediate turbine 49 powers drive shaft 69 that drives intermediate compressor 47 and possibly booster compressor 20 (as described above with respect to FIG. 8). Gas turbine engine 90 in FIG. 12 will be discussed in greater detail herein, but also utilizes a cooling system 126 like that described above.

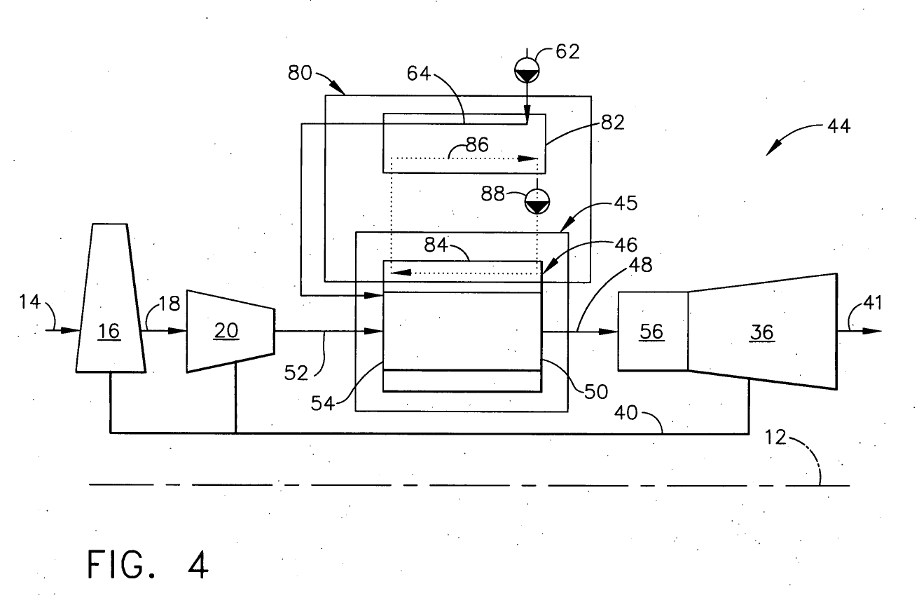

As seen in FIG. 4, gas turbine engine 44 includes a second alternative cooling system 80 in which fuel 64 is indirectly utilized to cool combustion system 46. More specifically, a first heat exchanger 82 (which is not integral with the walls of combustion system 46) and a second heat exchanger 84 (which is integral with the walls of combustion system 46) are provided. It will be seen that an intermediate fluid 86 flows between first and second heat exchangers 82 and 84 and is utilized to cool combustion system 46. As intermediate fluid 86 transits first heat exchanger 82, fuel 64 is introduced to first heat exchanger 82 to cool such intermediate fluid 86. In its cooled state, intermediate fluid 86 is provided to second heat exchanger 84 where it absorbs heat from the hot walls of combustion system 46 and provides cooling thereto without the need for cooling air. It will be seen that a separate pump 88 is preferably provided for moving intermediate fluid 86 between first and second heat exchangers 82 and 84.

Further, it will be appreciated that fuel 64 flowing through first heat exchanger 82 is preferably heated by intermediate fluid 86 prior to entering inlet 54 of combustion system 46. In this way, initiating the combustion process in combustion system 46, whether as a detonation or a deflagration, is made easier.

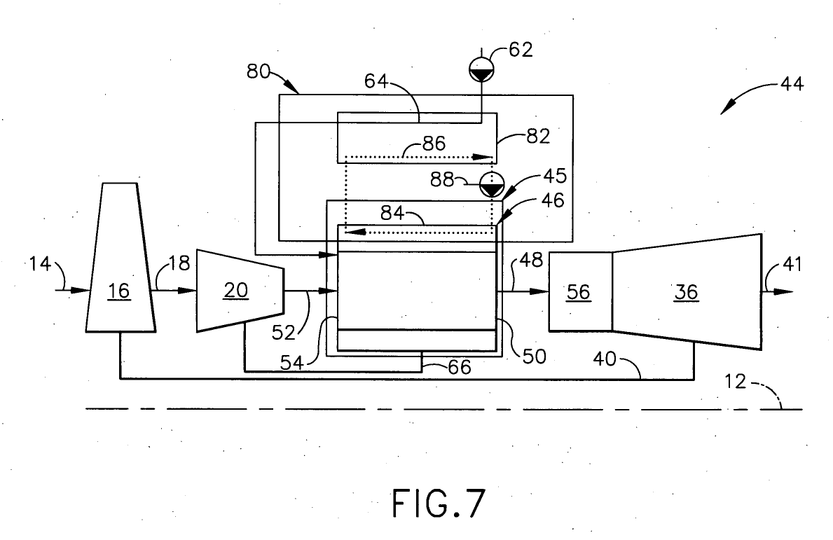

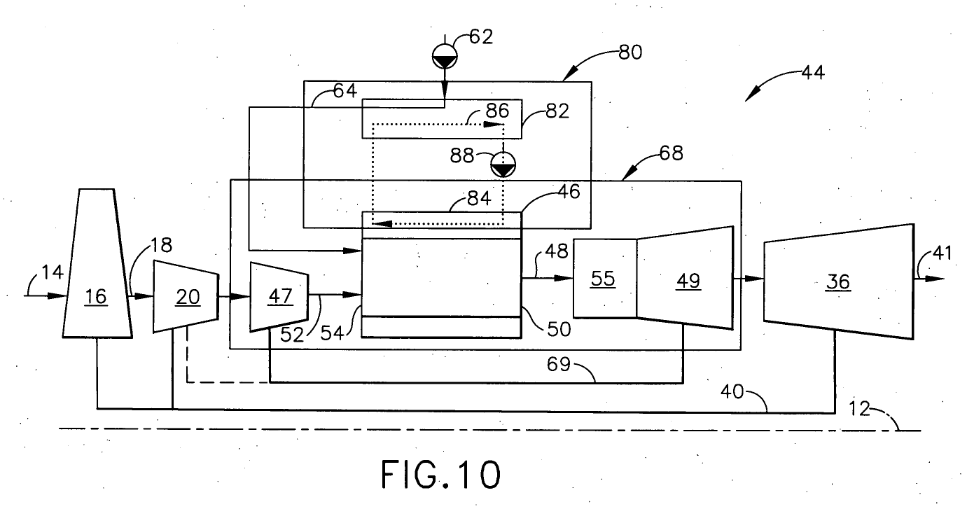

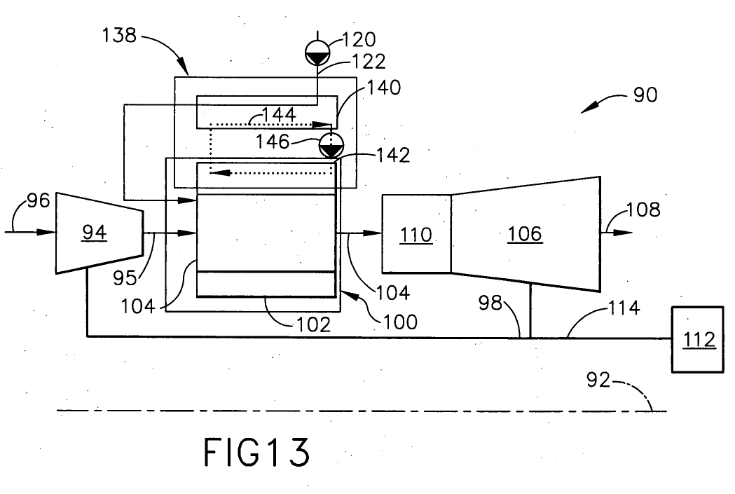

Cooling system 80 may also be implemented in other gas turbine configurations, as seen in FIGS. 7, 10 and 13. With respect to FIG. 7, combustion system 46 includes a rotatable member so that it powers drive shaft 66 (as discussed above for FIG. 5) and therefore preferably drives booster compressor 20. In this way, low pressure turbine 36 is able to drive fan section 16 separately via drive shaft 40. In FIG. 10, core system 68 preferably includes intermediate compressor 47 located immediately downstream of booster compressor 20 and intermediate turbine 49 positioned between combustion system 46 and low pressure turbine 36. Thus, intermediate turbine 49 powers drive shaft 69 that drives intermediate compressor 47 and possibly booster compressor 20 (as described above with respect to FIG. 8). Gas turbine engine 90 in FIG. 13 will be discussed in greater detail herein, but also utilizes a cooling system 138 like that described above.

The present invention also contemplates a method of cooling combustion system 46 of gas turbine engine 44, where booster compressor 20 includes a plurality of stages and working fluid 48 is discharged from such combustion systems. This method includes the steps of providing fuel 64 as a cooling fluid to cool such respective combustion system 46 and supplying fuel 64 thereafter to combustion system 46. It will be noted that fuel 64 may perform its cooling function directly (as in cooling system 58 of FIG. 2) or indirectly (as in cooling systems 70 and 80 of FIGS. 3 and 4).

FIG. 11 depicts an alternative gas turbine engine 90 for use in industrial and other shaft power applications (e.g., marine or helicopter propulsion) as having a longitudinal centerline axis 92. As seen therein, gas turbine engine 90 includes a compressor 94 in flow communication with a flow of air (represented by an arrow 96). Compressor 94 preferably includes at least a first stationary compressor blade row and a second rotating compressor blade row connected to a first drive shaft 98 and interdigitated with the first stationary compressor blade row. Additional compressor blade rows may be connected to drive shaft 98, with additional stationary compressor blade rows interdigitated therewith. An inlet guide vane (not shown) may be positioned at an upstream end of compressor 94 to direct the flow of air therein. A core system 100 having a stationary combustion system 102, like that described hereinabove with respect to FIGS. 2-4, provides a working fluid 104 to a low pressure turbine 106 that powers first drive shaft 98. Combustion gases (represented by an arrow 108) then exit from low pressure turbine 106 and are exhausted. It will be understood that core system 100 of gas turbine engine 90 may include a combustion system that is rotatable (see FIGS. 5-7) or an intermediate compressor and intermediate turbine associated with combustion system 102 (see FIGS. 8-10).

It will be seen that working fluid 104 is preferably provided to a turbine nozzle 110 positioned immediately upstream of low pressure turbine 106 so as to direct its flow at an optimum orientation into low pressure turbine 106. In the embodiment depicted in FIG. 11, low pressure turbine 106 drives both compressor 94 (which provides compressed air 95 to combustion system 102) by means of first drive shaft 98 and a load 112 by means of a second drive shaft 114.

As similarly described herein with respect to FIG. 2, a cooling system identified generally by reference numeral 116 is associated with core system 100, where a heat exchanger 118 is preferably integrated with combustion system 102.

More specifically, it will be seen that a pump 120 provides fuel 122 directly to heat exchanger 118 prior to entering inlet 124 of combustion system 102. In this way, the sensible heat of fuel 122 and latent heat of vaporization allows fuel 122 to absorb heat from the hot walls of combustion system 102 and provide cooling thereto without the need for cooling air. In addition to cooling combustion system 102, fuel 122 is vaporized during the transit time through heat exchanger 118 prior to injection into combustion system 102. As such, initiating detonation in combustion system 102, whether as a detonation or a deflagration, is easier in a gaseous or vaporized state than as a liquid.

As similarly described with respect to FIG. 3, gas turbine engine 90 in FIG. 12 includes an alternative cooling system 126 in which fuel 122 is indirectly utilized to cool combustion system 102. More specifically, a heat exchanger 128 which is not integral with the walls of combustion system 102 is provided. Compressed air 130 is provided to heat exchanger 128 from compressor 94, which is cooled by the introduction of fuel 122 to heat exchanger 128. Thereafter, a flow of cooled compressed air 132 is utilized to cool combustion system 102. The transfer of heat from compressed air 130 to fuel 122 in heat exchanger 128 promotes the vaporization of fuel 122 prior to being injected at inlet 124 of combustion system 102. It will be appreciated that the pressure of cooling flow 132 must be greater than compressed flow 95 provided to combustion system 102. Accordingly, it is preferred that compressed flow 95 originate from a first source 134 (e.g., a port at a mid-stage of compressor 94) which is upstream of a second source 136 (e.g., an aft end of compressor 94) that provides compressed flow 130 to cooling system 126. By configuring cooling system 126 this way, the concerns of fuel 122 gumming or coking as in cooling system 116 are avoided. Moreover, as noted in the '______ and '______ patent applications, introducing cooling flow 132 to turbine nozzle 110 provides the added benefit of damping the unsteadiness of working fluid 104 provided to low pressure turbine 106. Further, noise is mitigated and smooth operation of gas turbine engine 90 is enabled.

As also described regarding FIG. 4, FIG. 13 depicts gas turbine engine 90 as including a second alternative cooling system 138 in which fuel 122 is indirectly utilized to cool combustion system 102. More specifically, a first heat exchanger 140 (which is not integral with the walls of combustion system 102) and a second heat exchanger 142 (which is integral with the wall of combustion system 102) are provided. It will be seen that an intermediate fluid 144 flows between first and second heat exchangers 140 and 142 and is utilized to cool combustion system 102. As intermediate fluid 144 transits first heat exchanger 140, fuel 122 is introduced to first heat exchanger 140 to cool such intermediate fluid 144. A pump 146 is preferably provided to move intermediate fluid 144 between first and second heat exchangers 140 and 142. In its cooled state, intermediate fluid 144 is provided to second heat exchanger 142 where it absorbs heat from the hot walls of combustion system 102 and provides cooling thereto without the need for cooling air. It will be appreciated that fuel 122 flowing through first heat exchanger 140 is preferably heated by intermediate fluid 144 prior to entering inlet 104 of combustion system 102. In this way, initiating detonation in combustion system 102, whether as a detonation or a deflagration, is made easier.

Having shown and described the preferred embodiment of the present invention, further adaptations of core systems 45, 68 and 100, and particularly combustion systems 46 and 102 can be accomplished by appropriate modifications by one of ordinary skill in the art without departing from the scope of the invention. Moreover, it will be understood that combustion systems 46, 58, 88 and 100 may be utilized with other types of gas turbine engines not depicted herein.

What is claimed is:

1. A system for cooling a combustion system of a gas turbine engine, comprising at least one heat exchanger independent from said combustion system, wherein fuel flowing through said first heat exchanger provides indirect cooling to said combustion system.

2. The cooling system of claim 1, further comprising compressed air in flow communication with said first heat exchanger, wherein said compressed air is cooled by said fuel and thereafter provides cooling to said combustion system.

3. The cooling system of claim 1, further comprising a second heat exchanger integral with said combustion system and an intermediate fluid flowing between said first and second heat exchangers, wherein said intermediate fluid is cooled by said fuel in said first heat exchanger and said intermediate fluid thereafter provides direct cooling to said combustion system through said second heat exchanger.

4. The cooling system of claim 1, wherein said combustion system is a constant volume combustor.

5. The cooling system of claim 1, wherein said combustion system is a pulse detonation device.

6. The cooling system of claim 1, wherein said combustion system includes at least one rotating member for powering said drive shaft.

7. The cooling system of claim 1, said gas turbine engine further comprising:
(a) a fan section at a forward end of said gas turbine engine including at least a first fan blade row connected to a first drive shaft;
(b) a booster compressor positioned downstream of and in at least partial flow communication with said fan section including a plurality of stages, each said stage including a stationary compressor blade row and a rotating compressor blade row connected to a drive shaft and interdigitated with said stationary compressor blade row;
(c) a combustion system positioned downstream of said booster compressor, said combustion system producing pulses of gas having increased pressure and temperature from a fluid flow provided to an inlet thereof so as to produce a working fluid at an outlet; and,
(d) a low pressure turbine positioned downstream of and in flow communication with said combustion system, said low pressure turbine being utilized to power said first drive shaft.

8. The cooling system of claim 7, said gas turbine engine further comprising an intermediate compressor downstream of and in flow communication with said booster compressor.

9. The cooling system of claim 8, said gas turbine engine further comprising an intermediate turbine positioned downstream of said combustion system in flow communication with said working fluid, said intermediate turbine being utilized to power a second drive shaft.

10. The cooling system of claim 9, wherein said fuel is provided to cool a working fluid entering said intermediate turbine.

11. The cooling system of claim 1, wherein said gas turbine engine is able to generate a maximum of approximately 30,000 pounds of thrust.

12. The cooling system of claim 10, wherein said gas turbine engine is able to generate a maximum of approximately 60,000 pounds of thrust.

13. The cooling system of claim 9, wherein said booster compressor is driven by said second drive shaft.

14. The cooling system of claim 1, said gas turbine engine further comprising:
(a) a compressor positioned at a forward end of said gas turbine engine having a plurality of stages, each said stage including a stationary compressor blade row and a rotatable blade row connected to a drive shaft and interdigitated with said first stationary compressor blade row;
(b) a combustion system positioned downstream of said compressor, said combustion system producing pulses of gas having increased pressure and temperature from a fluid supplied to an inlet thereof so as to produce a working fluid at an outlet thereof,
(c) a turbine downstream of and in flow communication with said combustion system for powering said drive shaft; and,
(d) a load connected to said drive shaft.

15. The cooling system of claim 14, said gas turbine engine further comprising:
(a) an intermediate compressor positioned downstream of and in flow communication with said compressor connected to a second drive shaft; and
(b) an intermediate turbine positioned downstream of said combustion system in flow communication with said working fluid.
